(19) United States
(12) Patent Application Publication
(10) Pub. No.: US 2009/0099725 A1
(43) Pub. Date: Apr. 16, 2009

(54) ELECTRONIC MILEAGE LOGGER

(76) Inventors: Michael R. PESCH, Lombard, IL (US); Brian SAPP, Lombard, IL (US)

Correspondence Address: ORUM & ROTH LLC, 53 W. JACKSON BLVD., SUITE 1616, CHICAGO, IL, 60604, US

(21) Appl. No.: 12/209,077

(22) Filed: Sep. 11, 2008

Related U.S. Application Data
(60) Provisional application No. 60/960,045, filed on Sep. 12, 2007.

(51) Int. Cl. G06F 19/00

(52) U.S. Cl. 701/35

(57) ABSTRACT

The electronic mileage logger has a GPS module, a processor module, a display module, a memory module, and an output module interoperably connected to allow recording, display and printing out of elapsed mileage. The memory module allows dedicated recording of trip mileage. Elapsed mileage is then stored in the memory module. The display module can display present trip mileage or mileage accumulated over a given period. The memory module retains recorded mileage until reset and cleared. The output module may be password protected and can format the mileage log for output to an external device or application, such as a printer, spreadsheet, or the like. Calibration of the mileage logger is provided during an initialization phase of the device.

### BACKGROUND OF THE INVENTION

1. Field of the Invention

The present invention relates generally to electronic appliances, and more particularly, to an electronic mileage logger for recording, displaying, and printing out mileage usage of a vehicle, pedestrian, or the like.

2. Description of the Related Art

Many businesses require strict compliance with their mileage logging requirements for business related usage of a vehicle, such as an automobile, motorcycle, bicycle, truck, boat, or the like. In the past, compliance with mileage requirements has generally been attempted by maintaining a handwritten log, within which is recorded the mileage covered for business-related activities. Such log entries are generally inconvenient and, more often than not, skipped over, thus creating inaccuracies in the log. As is generally known by anyone having experience maintaining such logs, it is difficult, if not impossible, to reconstruct one's itinerary with sufficient accuracy to enter the correct missing data in the trip log.

There is, therefore, a need for a system that permits one to record trip mileage for a plurality of trips in various stages of progress, and to be able to format the trip record in a document that can be utilized by a spreadsheet, map program, or merely by being printed out. There is not presently available such a solution to tracking miles traveled for business expenses, reimbursement, taxable credit, or the like.

Thus, an electronic mileage logger solving the aforementioned problems is desired.

### SUMMARY OF THE INVENTION

The electronic mileage logger has a Global Positioning System (GPS) module, a processor module, a display module, a memory module, and an output module interoperably connected to each other to allow recording and display of elapsed mileage. The memory module allows dedicated recording of trip mileage. Elapsed mileage is then stored in the memory module. The display module can display present trip mileage or mileage accumulated over a given period. The memory module retains recorded mileage until reset and cleared. An output module may be password protected and can format the mileage log for output to an external device or application, such as a printer, spreadsheet, or the like. Calibration of the mileage log is provided during an initialization phase of the device.

These and other features of the present invention will become readily apparent upon further review of the following specification and drawings.

### BRIEF DESCRIPTION OF THE DRAWINGS

FIG. 1A is an environmental, perspective view of an electronic mileage logger according to the present invention.

FIG. 1B is a current trip screen process flowchart of the electronic mileage logger according to the present invention.

FIG. 2 is a functional block diagram of the electronic mileage logger according to the present invention.

FIG. 3 is a hierarchical block diagram showing the relationship between screens in an electronic mileage logger according to the present invention.

FIG. 4A is an exemplary screenshot of a startup screen for an electronic mileage logger according to the present invention.

FIG. 4B is a flowchart showing the steps of starting up an electronic mileage logger according to the present invention.

FIG. 5A is an exemplary screenshot of an initialization screen for an electronic mileage logger according to the present invention.

FIG. 5B is a flowchart showing the steps in an initialization screen process for an electronic mileage logger according to the present invention.

FIG. 6A is an exemplary screenshot of an information screen for an electronic mileage logger according to the present invention.

FIG. 6B is a flowchart showing the steps of an information screen process for an electronic mileage logger according to the present invention.

FIG. 7A is an exemplary screenshot of a logged trip screen for an electronic mileage logger according to the present invention.

FIG. 7B is a flowchart showing the steps of a logged trip screen process for an electronic mileage logger according to the present invention.

FIG. 8A is an exemplary screenshot of a download screen for an electronic mileage logger according to the present invention.

FIG. 8B is a flowchart showing the steps of a download screen process for an electronic mileage logger according to the present invention.

FIG. 9A is an exemplary screenshot of a settings screen for an electronic mileage logger according to the present invention.

FIG. 9B is a flowchart showing the steps of a settings screen process for an electronic mileage logger according to the present invention.

FIG. 10 is an exemplary screenshot of a password screen for an electronic mileage logger according to the present invention.

Similar reference characters denote corresponding features consistently throughout the attached drawings.

### DETAILED DESCRIPTION OF THE PREFERRED EMBODIMENT

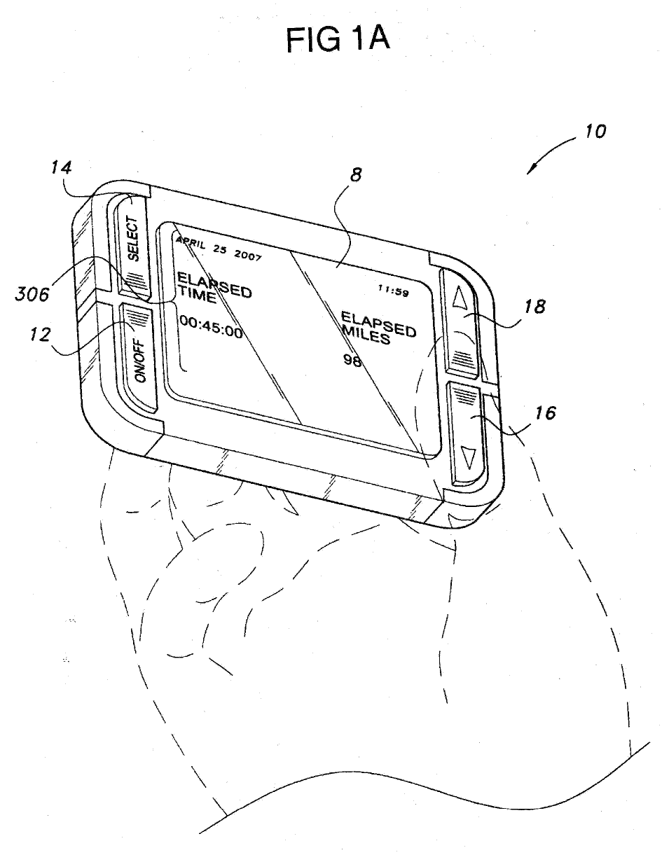

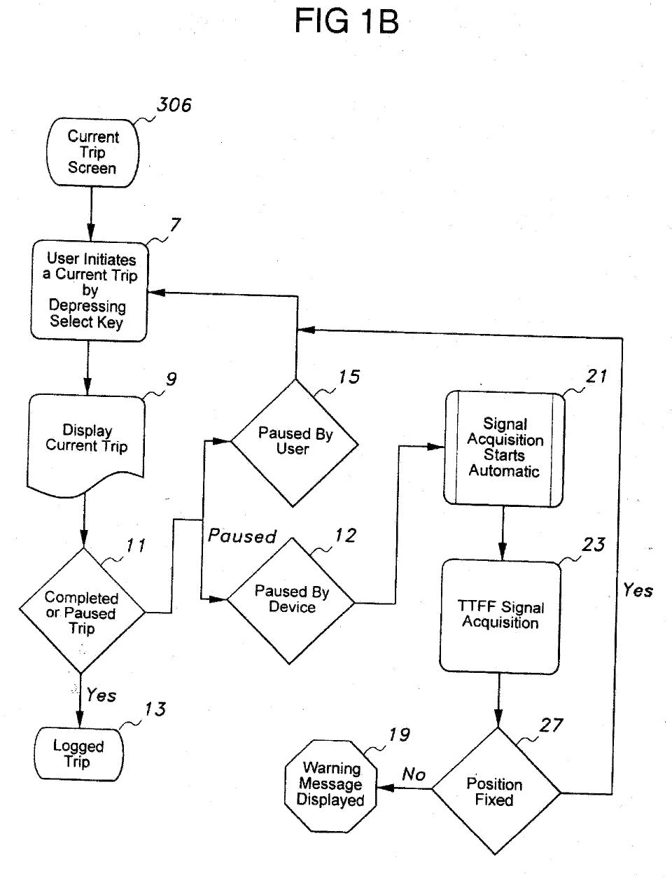

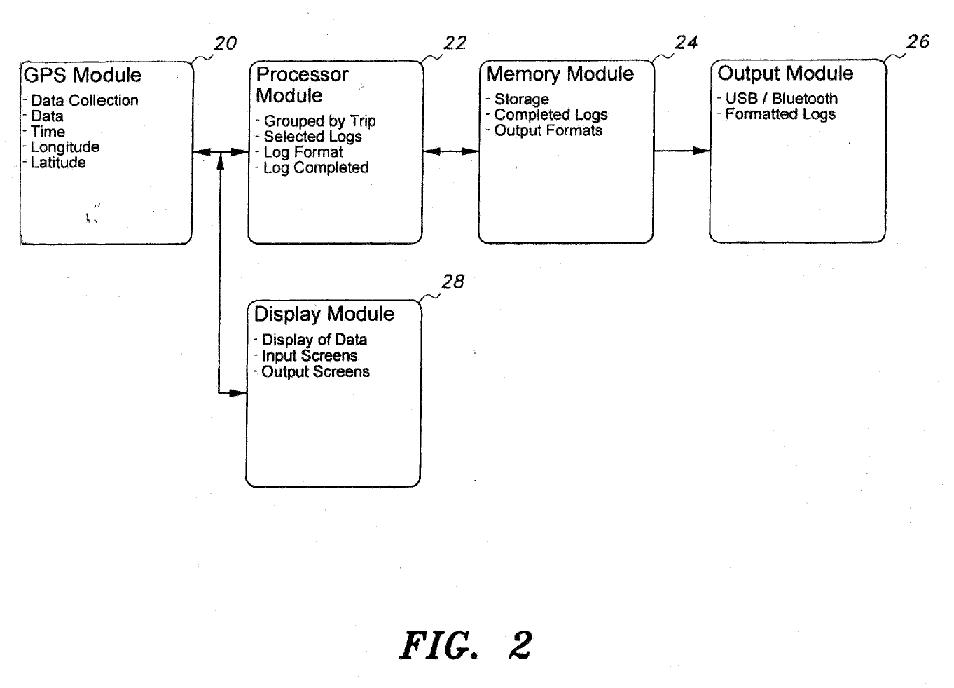

As shown in FIG. 1A, the present invention is an autonomous electronic mileage logger 10 having an up arrow scrolling button 18, a down arrow scrolling button 16, an LCD screen 8, a select button 14, and a power button 12, and is preferably compact, transportable, and easily handheld. As shown in FIG. 2, the mileage logger 10 has a GPS module 20, a processor module 22, a display module 28, a memory module 24, and an output module 26, which are interoperably connected to allow recording and display of elapsed mileage.

The GPS module 20 performs position tracking, which includes the time and date of the initiated log for positional data that is produced during the logged trip. The Date, Time, and Positional Data information is routed to the processor module 22.

The processor module 22 processes all data that is provided by the GPS module and compiles each data set into selected logged trips. The processor 22 can group selected trips by date and time, trips having a paused status, and trips having an incomplete status. The trip logs will also include the NMEA (National Marine Electronics Association)/GPGGA (Global Positioning System Fix Data), which can be utilized with many commercially available moving map software packages, such as Google™ Earth.

The memory module 24 facilitates dedicated recording of trip mileage. Elapsed mileage is then stored in the memory module 24.

The display module 28 can display present trip mileage or mileage accumulated over a given period. Moreover, the display module 28 will display all data required to fulfill each required screen. The display information will be compiled and driven from the processor module 22.

The memory module 24 retains recorded mileage until reset and cleared. Additionally, the memory module 24 will store all compiled trip logs and detailed NMEA position points for all logged trips. When a user selects what information that they require for downloading, the processor module 22 will tag the appropriate log files for the output process.

The output module 26 may be password protected and can format the mileage log for output to an external device or application, such as a printer, spreadsheet, or the like. The output module 26 will interface between the mileage logger 10 and a user's computer for downloading the selected formatted log files.

Calibration of the mileage logger 10 is provided during an initialization phase of the device.

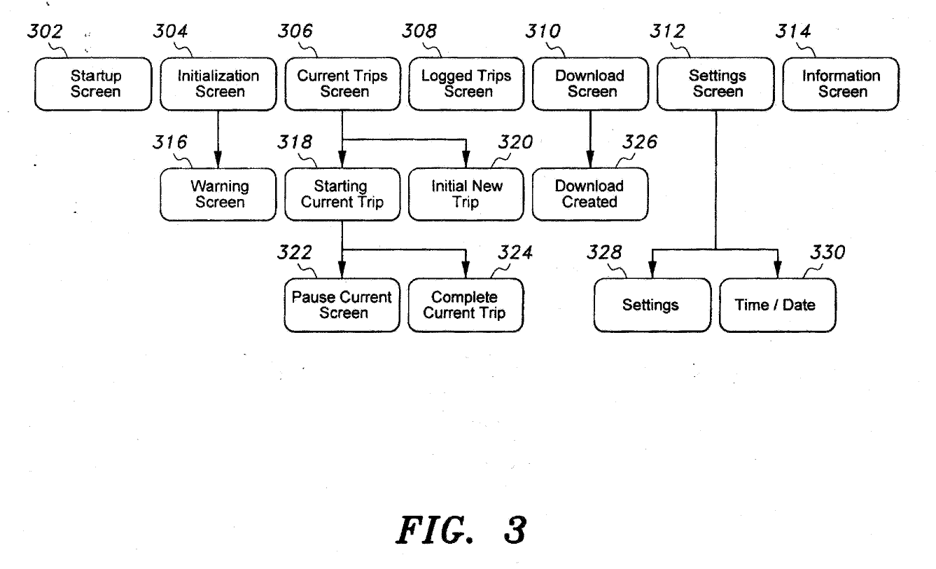

As shown in FIGS. 1A-1B, a current trip screen 306 can be initiated by depressing the “Select” key 14 at step 7. The user can activate the process of logging the current trip by depressing the Select key 14 to initiate a trip log. The user can pause a current trip by depressing the Select key 14 momentarily, after which a “pause trip” child screen 322 (shown diagrammatically in FIG. 3) will appear, notifying the user that the current trip has been paused. The user then can reestablish the current trip by depressing the select button 14 momentarily to cause the device to return to the current trips screen 306 and resume recording the trip. Once the user has completed the initiated current trip, the device 10 will store all data points for that specific logged trip. While in the current trips screen 306, the user can initiate another current trip by depressing the up arrow 18 once, which will take the user back to an initialized current trips screen 306, allowing the user the ability to initiate a new current trip.

During a current trip, if the device looses adequate signal strength momentarily, the device 10 will pause the current trip and re-establish the ‘Positional Fix’ needed to continue to log the current trip. This action requires no user interaction with the device 10. Once the ‘Positional Fix’ is reestablished, the device 10 will resume the paused current trip without user interaction. As shown at step 9 of FIG. 1B, the LCD screen 8 will then show a current trip display. As indicated at step 11, if a trip is completed, then a logged trip screen is displayed, as indicated at step 13. As shown at steps 12 and 15, if the device 10 was paused by a user, the device 10 waits at step 7 for the user to initiate another trip. If the device 10 was paused by itself, then, as shown in step 21, GPS signal acquisition starts automatically. Total time for first fix (TTFF) signal acquisition takes place at step 23. At steps 27 and 19, if the position cannot be fixed, a warning message is displayed. At steps 27 and 7, if the position is fixed, then processing waits for a user-initiated current trip mode.

As shown in FIG. 3, the device 10 may have a plurality of screen views presented by LCD 8. A user is able to cycle through the screens utilizing sequences or combinations of up arrow scrolling button 18, down arrow scrolling button 16 and select button 14 to move from parent screen to child screen. As shown in FIG. 3, the screens are broken down into three levels, Parent Screens, Child Screens, and Sub Child Screens. The Parent screens are the top-level screens 302, 304, 306, 308, 310, 312, and 314 and contain most of the crucial/critical data that users will interface with when using the logger 10. The Child screens, 316, 318, 320, 326, 328 and 330 are supporting screens that will allow a user the ability to make selections reflecting or initiating an event or an event sequence. Sub-Child screens, e.g., screens 322 and 324 are screens that are subordinate to the Child Screens and Parent Screens. Selection may be made by completing a logged trip 324 or resuming a paused trip 322 before returning to the Parent or Child screens.

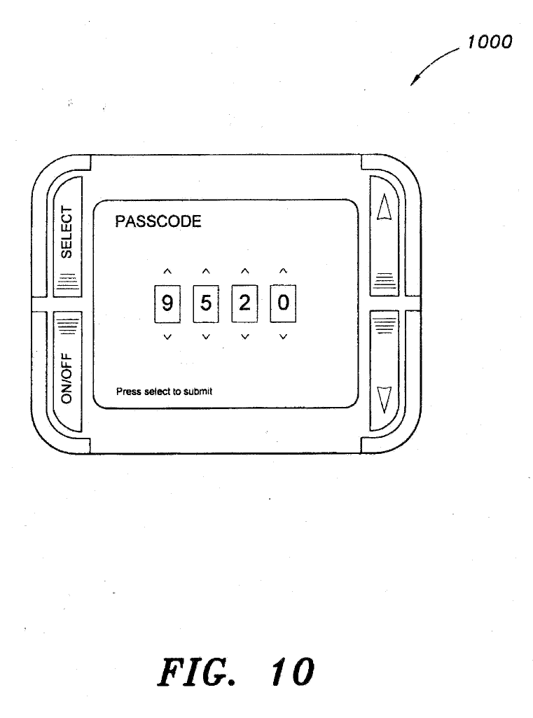

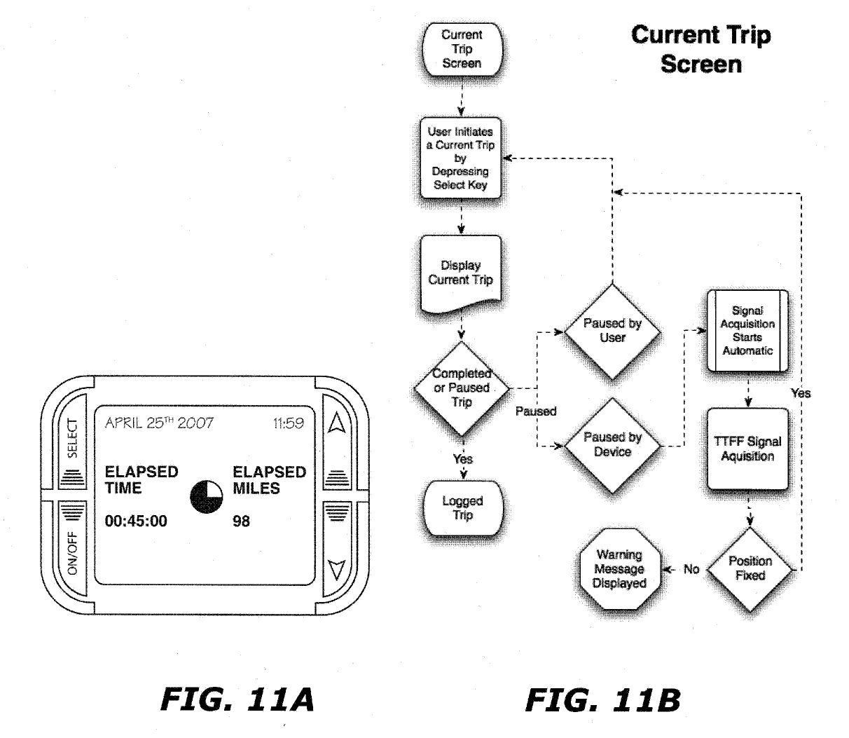

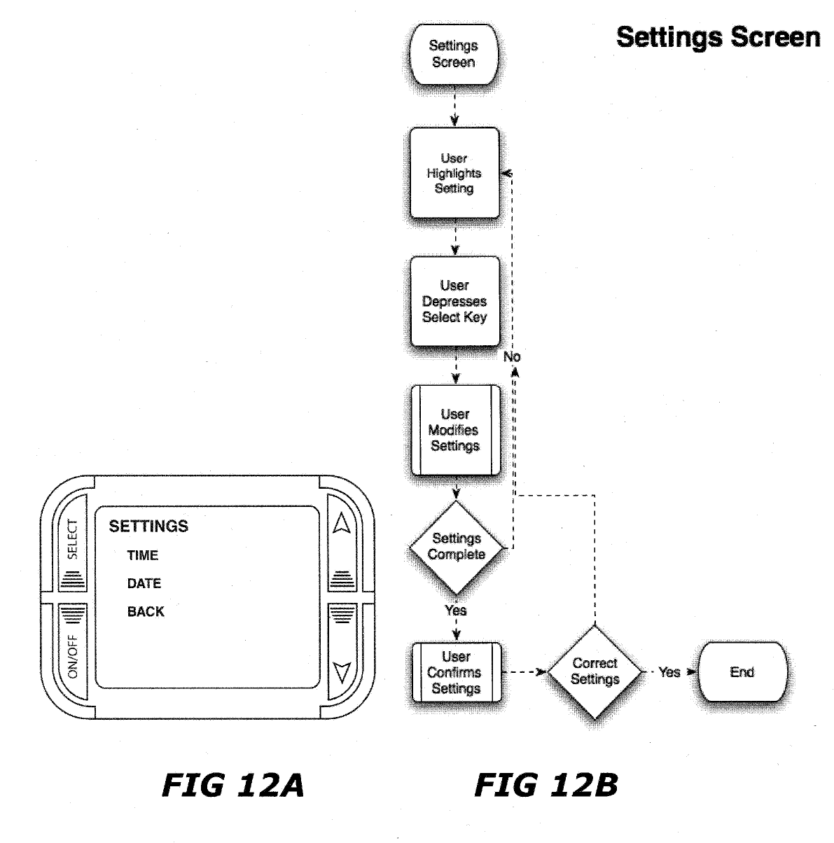

As previously mentioned, a startup screen 302 may be provided. In addition, device 10 provides an initialization screen 304, a current trips screen 306, a logged trips screen 308, a download screen 310, a settings screen 312, and information screen 314, a warning screen 316, a starting current trip screen 318, an initial new trip screen 320, a download created screen 326, a pause current screen 322, and a complete current trip screen 324. The settings screen 312 branches into a settings subdisplay 328 or, alternatively, to a time/date subdisplay 330. A screen or combination of screens may be password protected against unauthorized access. For example, password security code may be implemented in processor 22 so that access to the download screen 310 or access to the settings screen 312 is permitted only after user entry of a passcode that must be entered by the user from a numeric or alphanumeric list presented on the display 8. FIG. 10 shows an exemplary password entry screen 1000.

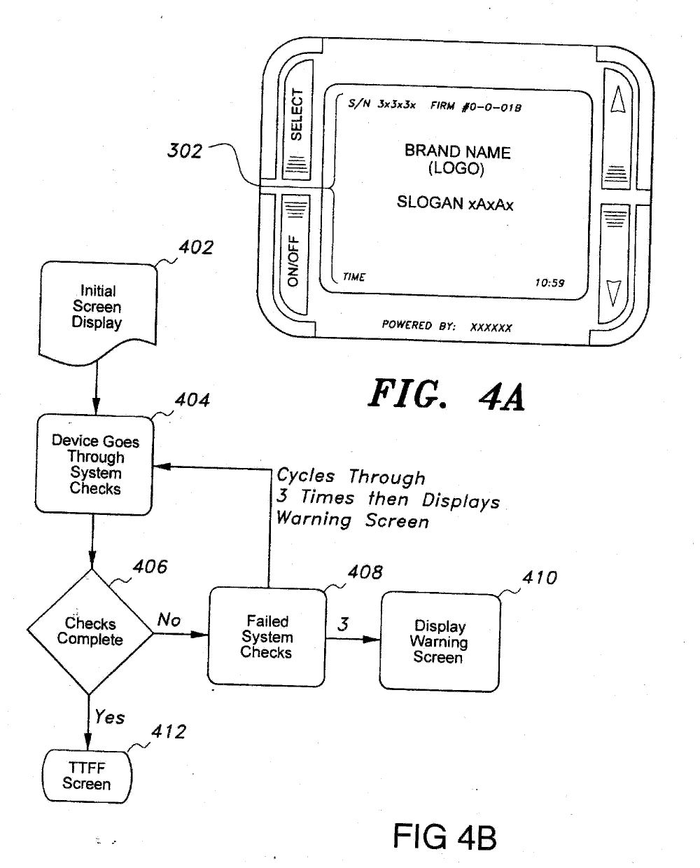

In addition, the processor 22 may have a customized passcode setting feature so that the authorized user can customize his/her passcode. FIG. 10 illustrates an exemplary passcode entry screen 1000. As shown in FIG. 4A, startup screen 302 may comprise basic information, such as device serial number, firmware, brand name, slogan, and time and date. The device 10 will display the startup information for a predetermined time period while the device 10 is going through an internal diagnostic program check. Once the diagnostic process is completed and all checks are satisfied the device 10 will proceed to the initialization screen without any user intervention.

As shown in FIG. 4B, from the startup screen 302, the device 10 enters an initial screen display at step 402. At step 404 the device 10 goes through system checks. At steps 406 and 412, if the checks complete, then the TTFF screen is displayed; otherwise, at step 408 a failed system check counter is initiated, and the device 10 returns processing to step 404. If the system checks fail a predetermined number of times, then, as shown at step 410, the warning screen 316 is presented to the user.

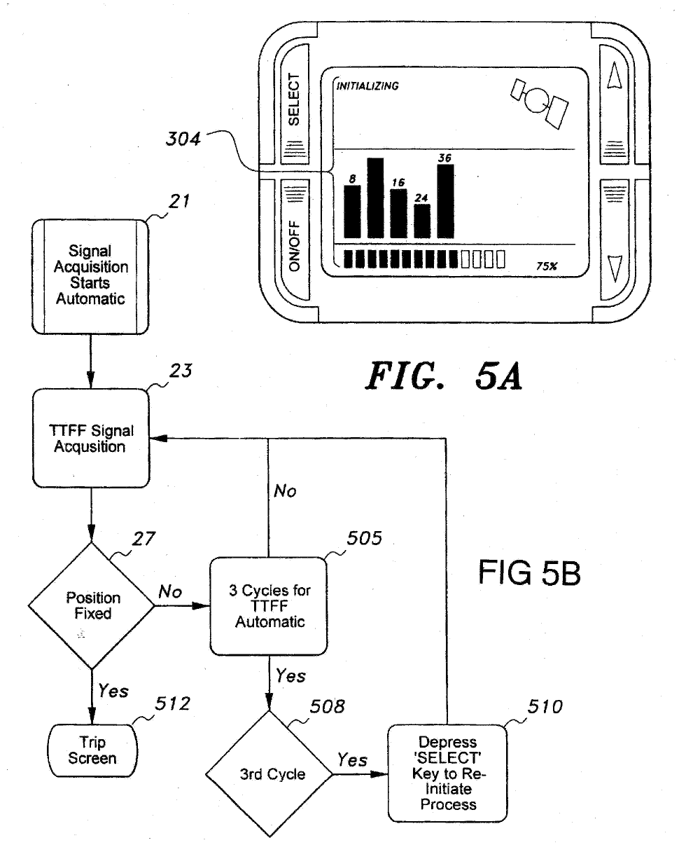

As shown in FIG. 5A, the initialization screen 304 may have a plurality of signal bars, a progress bar and an “initializing” indicator. It should be understood that if a position fix does not occur at step 27, then automatic TTFF is attempted a predetermined number of times at steps 505 (shown in FIG. 5B) and 23. If the position can be fixed then the trip screen is displayed at step 512. If the predetermined number of times for TTFF automatic acquisition has been expended, then, as shown in step 508 and step 510, the user is directed to depress select button 14 to reinitiate the process.

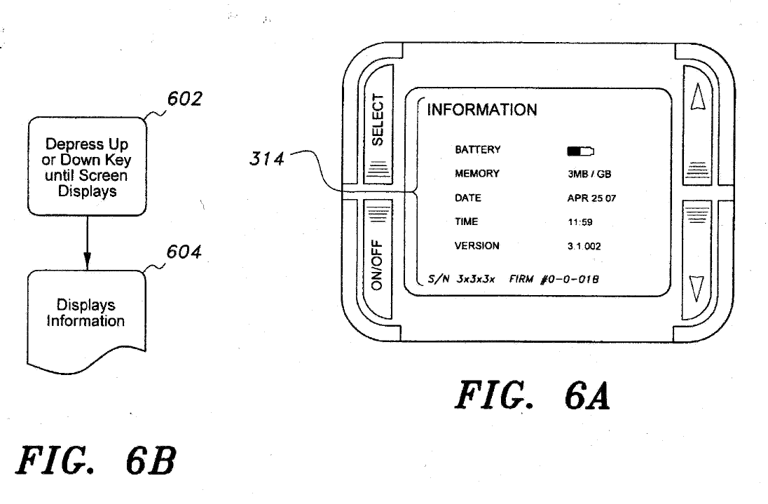

As shown in FIGS. 6A and 6B, at steps 602 and 604, responsive to user manipulation of scroll keys 16 and 18, an information screen 314 is presented. The information screen 314 may display battery, memory, date, time, and version information.

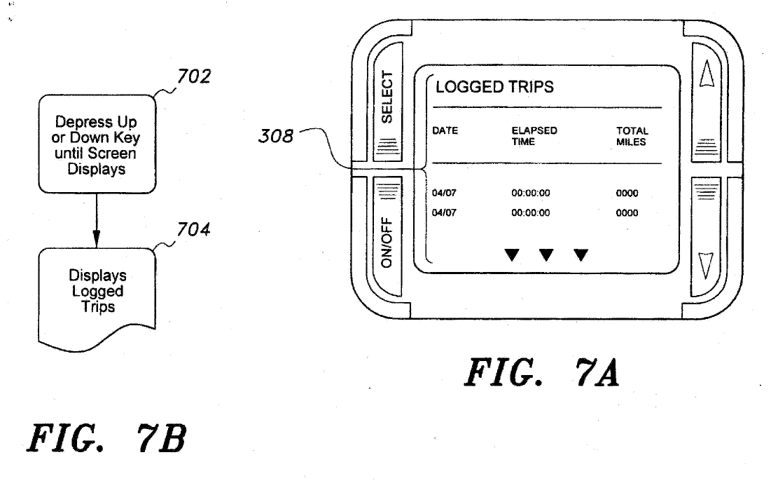

As shown in FIGS. 7A and 7B, at steps 702 and 704, responsive to user manipulation of scroll keys 16 and 18, a logged trips screen 308 is presented. The logged trips screen 308 can display date, elapsed time, and total miles of a trip. The user can access either the Logged Trips Screen 308 or the Information Screen 314 at any time once the device is powered up by depressing either the up arrow 18 or the down arrow 16 to scroll through the different screens until the desired parent screen is displayed. The Logged Trips Screen 308 will display the entire current logged trips in either most recent or in chronological order. This preference can be selected in the Settings Screen 312. The user can scroll up or down through the log by depressing the up arrow 18 or down arrow 16.

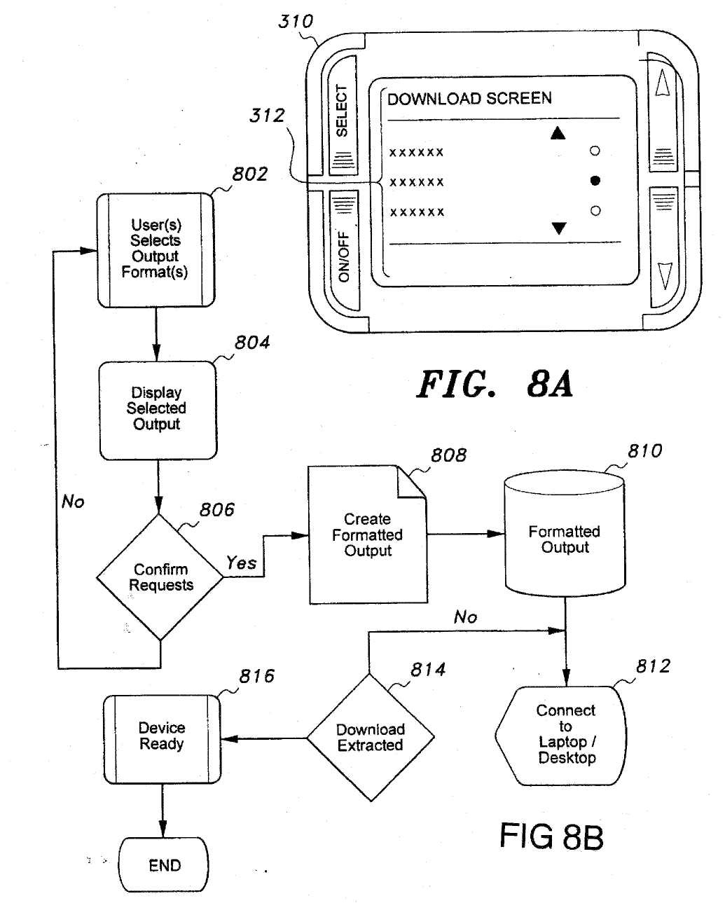

As shown in FIGS. 8A and 8B, a download screen 310 can be presented. The download screen 310 can display indicia to indicate download progress of trip data. At step 802, the user can select from a plurality of output formats. At step 804, the unit 10 displays the user-selected output. At step 806, the unit 10 may request confirmation of the user-selected output type. If the user confirms, then, at step 808, the device 10 creates the output in the desired format. Otherwise, the unit 10 waits for the user to select another output format at step 802. At step 810, the formatted output is stored in device memory. At steps 812, 814 and 816, an external device may be connected to the unit 10 for download extraction of the formatted trip data. The download screen gives the user the ability to extract the data formatted in the way that is the most useful to the user. There may be a plurality of option choices, such as a simple text formatted output, a Word™ type document, or a comma-separated value file (CSV)™ or Excel™ format. Moreover, flat file RAW data can be provided for importation into any type of moving map software. Additionally, a format that will import directly into Google™ Earth can be provided.

Using the download screen 310, any combination of output formats required by the user may be selected. The user accomplish this by scrolling through the menu utilizing the up 18 and down 16 arrow keys until they come upon a selection that they require. The user will depress the select key 14 to select the desired options. Once all selections have been made, the device 10 will display a child screen that will display the current selected options and ask the user to confirm the selections before the device formats the output. The formatted output file will be stored in the memory module 24, ready for downloading. The logger 10 provides the user with the capability to connect the logger 10 to a laptop, PDA, desktop computer, or the like.

The logger 10 is configured to be recognized as a simple removable storage device with the selected output files in a folder ready for drag and drop to the external device.

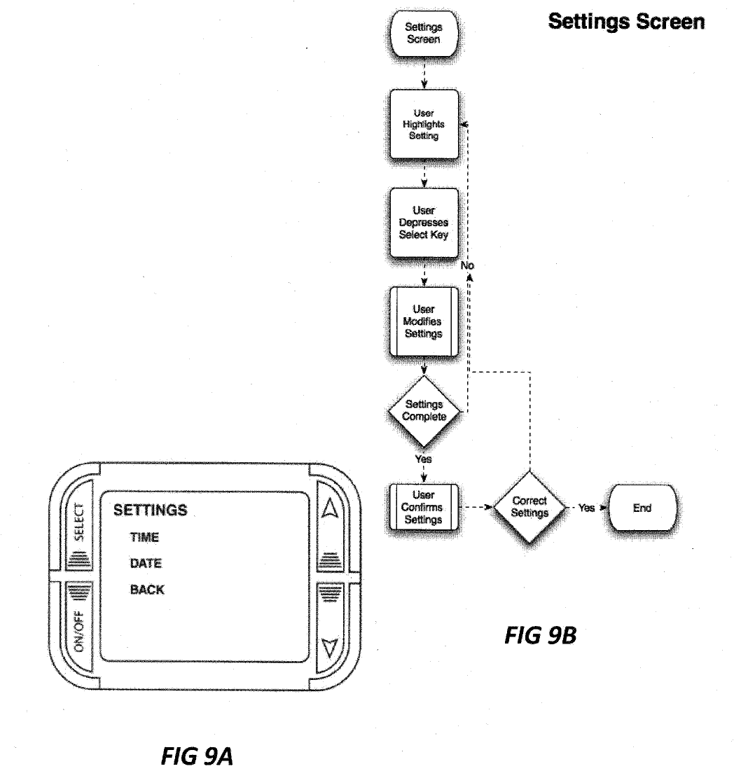

As shown in FIGS. 9A and 9B, a settings screen 312 can be presented. At step 902 the user can highlight a setting. At step 904, the highlighted setting can be selected using the select key 14. At step 906, the setting can be modified by the user. At step 908, if the settings are not complete, then the unit 10 returns to step 902. At step 910, the user is given the opportunity to confirm completed settings. At step 912, the unit 10 verifies whether the settings are correct, and if the settings are not correct, processing returns to step 902.

It is to be understood that the present invention is not limited to the embodiment described above, but encompasses any and all embodiments within the scope of the following claims.

We claim:

1. An electronic mileage logger, comprising:
a GPS module;
a processor module connected to the GPS module;
a display module connected to the processor module;
a memory module connected to the processor module;
an output module connected to the processor module; and
means for recording, displaying and outputting an elapsed trip mileage log.
